(19) United States
(12) Patent Application Publication
(10) Pub. No.: US 2026/0191630 A1
(43) Pub. Date: Jul. 9, 2026

(54) MOUTHPIECE FOR WHITENING TEETH

(71) Applicant: LAV CO., LTD., Seoul (KR)

(72) Inventors: JEONGWOO CHOI, Seoul (KR); JAEMYOUNG LEE, Yongin-si (KR)

(21) Appl. No.: 19/389,557

(22) Filed: Nov. 14, 2025

(30) Foreign Application Priority Data
Jan. 9, 2025 (KR) 10-2025-0003353

(51) Int. Cl. A61C 19/06

(52) U.S. Cl. CPC A61C 19/066

(57) ABSTRACT

Disclosed is a mouthpiece for whitening teeth enhancing user breathing convenience by forming an improved ventilation passage structure for smooth airflow. According to an aspect of the present invention, a mouthpiece for whitening teeth, comprises a main body, which is formed in an arc shape having an outer surface and an inner surface, comprises a ventilation passage formed to penetrate the outer and inner surfaces, and is formed in a flexible structure so that its orientation and shape can be flexibly adjusted according to the user's oral structure; a bite, which extends a predetermined length inward from the inner surface of the main body in an arc shape, providing a biting surface during use; a tongue rest, which extends inward from the inner surface of the bite; and a handle, which extends outward from the outer surface of the main body.

### CROSS-REFERENCE TO RELATED PATENT APPLICATION

This application claims priority to Korean Patent Application No. 10-205-0003353, filed on January 9, 2025, in the Korean Intellectual Property Office, the disclosures of which are incorporated by reference herein in their entireties.

### TECHNICAL FIELD

The present invention relates to a mouthpiece for whitening teeth, and more specifically, to a mouthpiece for whitening teeth that includes structural improvements designed to enhance user breathing convenience and improve the whitening effect by preventing the saliva-induced dilution of the teeth whitening gel.

### BACKGROUND OF THE INVENTION

Teeth whitening is a widely used technology to meet the aesthetic demands of modern people, and it is generally performed by applying a formulation containing a whitening agent to the tooth surface. Currently, whitening devices include strip type, pen type, cheek retractor type, and mouthpiece type.

The strip type involves attaching a thin strip containing the whitening agent to the tooth surface. While easy to use, the strip easily detaches due to saliva, posing a problem of not achieving a sufficient whitening effect.

The pen type involves directly applying the whitening gel to the tooth surface. While relatively simple, it presents the problem of the applied gel mixing with saliva, causing dilution or running off.

The cheek retractor type involves applying the whitening agent to the tooth surface while fixing the user's lips in an open state. However, it requires maintaining an open mouth for a long time, causing a burden on the lips and temporomandibular joint, and resulting in discomfort during use.

The mouthpiece type provides a teeth whitening effect by applying a teeth whitening gel to the inner wall of the mouthpiece and having the user bite down on it. However, it has limitations, such as the whitening gel being diluted by mixing with saliva, or causing breathing difficulties for users who find it difficult to breathe through the nose. Furthermore, the movement of the tongue may promote saliva secretion, which accelerates the dilution of the whitening gel.

### SUMMARY OF THE INVENTION

According to an aspect of the present invention, a mouthpiece for whitening teeth, comprises a main body, which is formed in an arc shape having an outer surface and an inner surface, comprises a ventilation passage formed to penetrate the outer and inner surfaces, and is formed in a flexible structure so that its orientation and shape can be flexibly adjusted according to the user's oral structure; a bite, which extends a predetermined length inward from the inner surface of the main body in an arc shape, providing a biting surface during use; a tongue rest, which extends inward from the inner surface of the bite; and a handle, which extends outward from the outer surface of the main body; wherein the bite includes: a ventilation assist, which protrudes a predetermined length vertically from the inner surface of the bite; and a first ventilation opening, which is formed in a predetermined size on one surface of the ventilation assist and is connected to the ventilation passage.

In addition, the bite may further comprise at least one bite groove formed to be concavely recessed toward the inner surface of the main body, and the orientation and shape are flexibly adjusted according to the user's oral structure by the bite groove.

In addition, the bite grooves may be formed in an even number and arranged symmetrically at left and right side.

Also, the ventilation assist may have a wall structure protruding vertically from the inner surface of the bite, wherein the ventilation assist is formed with a predetermined thickness to maintain smooth airflow in the ventilation passage.

The mouthpiece for whitening teeth of claim may further comprise a handle assist connecting the outer surface of the main body and the handle; and a second ventilation opening formed in a predetermined size on at least one surface of the handle assist and connected to the ventilation passage.

In addition, the second ventilation openings are formed in a plurality of openings on one surface of the handle assist, symmetrical with respect to the centerline of the handle, wherein the ventilation passage is branched into multiple paths from the first ventilation opening and extended to each of the plurality of second ventilation openings.

Also, the inner surface of the main body may further comprise a plurality of protrusions formed to protrude, enhancing the adhesion of the teeth whitening gel so that the teeth whitening gel is uniformly applied to the tooth surface.

In addition, the inner surface of the main body may further comprise a plurality of linear grooves to enhance the adhesion of the teeth whitening gel so that the teeth whitening gel is uniformly applied to the tooth surface.

Also, the average thickness of the main body may be 1 to 2 mm.

In addition, the tongue rest may be connected to the ventilation assist to stably hold the user's tongue and fix its position inside the oral cavity.

In addition, the handle may be integrally formed with the main body to assist the user in easily putting on and removing the mouthpiece.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 is a front perspective view of a mouthpiece for whitening teeth according to a preferred embodiment.

FIG. 2 is a top view of a mouthpiece for whitening teeth according to a preferred embodiment.

FIG. 3 is a schematic diagram illustrating the size change of a mouthpiece for whitening teeth according to a preferred embodiment.

FIG. 4 is a view illustrating the inner surface of a mouthpiece for whitening teeth according to a preferred embodiment.

FIG. 5 is a front perspective view of a mouthpiece for whitening teeth according to a preferred embodiment.

FIG. 6 is a cross-sectional view illustrating the ventilation passage and ventilation openings of a mouthpiece for whitening teeth according to a preferred embodiment.

FIG. 7 is a cross-sectional view illustrating the ventilation passage and ventilation openings of a mouthpiece for whitening teeth according to a preferred embodiment.

FIG. 8 is a cross-sectional view illustrating the ventilation passage and ventilation openings of a mouthpiece for whitening teeth according to a preferred embodiment.

FIG. 9 is a cross-sectional view illustrating the ventilation passage and ventilation openings of a mouthpiece for whitening teeth according to a preferred embodiment.

FIG. 10 is a view illustrating the state of use of a mouthpiece for whitening teeth according to a preferred embodiment.

FIG. 11 is a view illustrating the state of use of a mouthpiece for whitening teeth according to a preferred embodiment.

### DETAILED DESCRIPTION

Hereinafter, embodiments of the present invention will be described in detail with reference to the accompanying drawings, which can be easily practiced by those skilled in the art.

As described above, the conventional mouthpiece-type teeth whitening device provides a teeth whitening effect by applying a teeth whitening gel to the inner wall of the mouthpiece and having the user bite down on it. However, it had limitations, such as the whitening gel being diluted by mixing with saliva, or causing breathing difficulties for users who find it difficult to breathe through the nose. Furthermore, the movement of the tongue also promoted saliva secretion, which accelerated the dilution of the whitening gel.

Accordingly, the present invention seeks to solve the above-mentioned limitations by providing a mouthpiece for whitening teeth comprising: a main body, which is formed in an arc shape having an outer surface and an inner surface, includes a ventilation passage formed to penetrate the outer and inner surfaces, and is formed in a flexible structure so that its orientation and shape can be flexibly adjusted according to the user's oral structure; a bite, which extends a predetermined length inward from the inner surface of the main body in an arc shape, providing a biting surface during use; a tongue rest, which extends inward from the inner surface of the bite; and a handle, which extends outward from the outer surface of the main body; wherein the bite includes a ventilation assist, which protrudes a predetermined length vertically from the inner surface of the bite; and a first ventilation opening, which is formed in a predetermined size on one surface of the ventilation assist and is connected to the ventilation passage.

Consequently, the present invention can enhance user breathing convenience by forming an improved ventilation passage structure for smooth airflow, and can improve the whitening effect by including structural improvements designed to block saliva inflow and, at the same time, enhance the adhesion of the teeth whitening gel, ensuring the teeth whitening gel is uniformly applied to the tooth surface.

Furthermore, being formed with a flexible structure allows its orientation and shape to be flexibly adjusted according to the user's oral structure, and the pressure generated during the occlusion of the user's upper and lower teeth is distributed, thereby alleviating the load applied to the user's temporomandibular joint and improving user convenience.

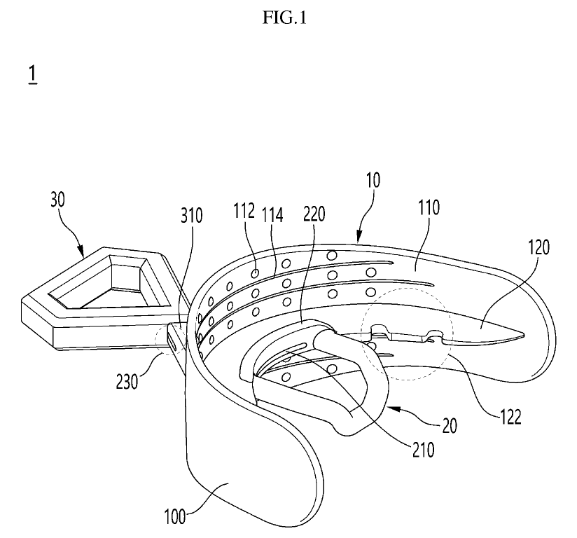

FIG. 1 is a front perspective view of a mouthpiece for whitening teeth according to a preferred embodiment.

Referring to FIG. 1, the mouthpiece for whitening teeth 1 includes a main body 10, a tongue rest 20, and a handle 30.

The main body 10 is formed in an arc shape having an outer surface 100 and an inner surface 110, includes a ventilation passage formed to penetrate the outer surface 100 and the inner surface 110, and is formed in a flexible structure so that its orientation and shape can be flexibly adjusted according to the user's oral structure.

The main body 10 includes a bite 120, which extends a predetermined length inward from the inner surface 110 in an arc shape, providing a biting surface during use.

The tongue rest 20 extends inward from the inner surface of the bite 120.

Furthermore, the handle 30 extends outward from the outer surface 100 of the main body 10.

The bite 120 includes a first ventilation opening 210 connected to the ventilation passage.

Specifically, the bite 120 includes a ventilation assist 220 protruding a predetermined length vertically from the inner surface, and first ventilation opening 210 formed in a predetermined size on one surface of the ventilation assist 220 and connected to the ventilation passage.

First, the main body 10 will be described more in detail.

The main body 10 is formed in an arc shape having an outer surface 100 and an inner surface 110 to be suitable for the user's oral structure, and includes a ventilation passage formed to penetrate the outer surface 100 and the inner surface 110.

The main body 10 may be formed of a flexible material, which can provide user convenience and comfort.

The average thickness of the main body 10 is preferably 1 to 2 mm, and more preferably 1.2 to 1.8 mm. In this case, having a relatively thin thickness compared to conventional teeth whitening mouthpieces can enhance the user's wearing comfort.

The main body 10 includes a bite 120 extending a predetermined length inward from the inner surface 110 in an arc shape, providing a biting surface during use. This allows the pressure generated during the occlusion of the user's upper and lower teeth to be distributed, thereby alleviating the load applied to the user's temporomandibular joint.

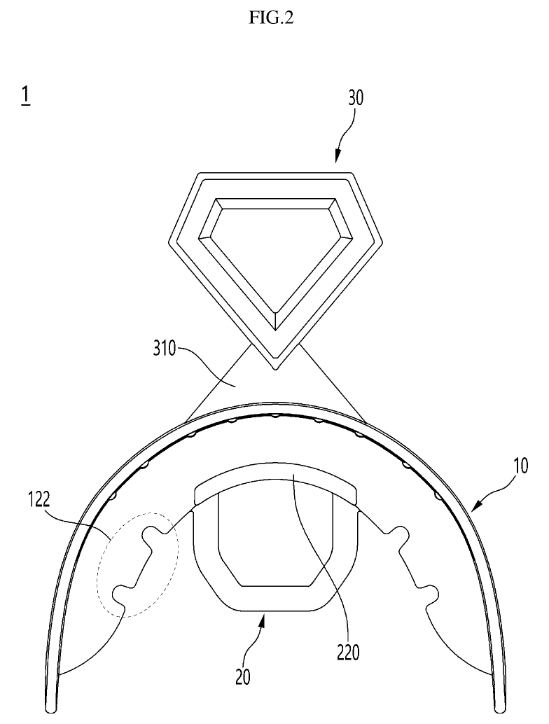

FIG. 2 is a top view of the mouthpiece for whitening teeth 1 according to a preferred embodiment.

Referring to FIG. 2, the mouthpiece includes a bite 120 extending a predetermined length inward from the inner surface 110 of the main body 10 in an arc shape, providing a biting surface during use.

Furthermore, the bite 120 may include at least one bite groove 122 formed to be concavely recessed toward the inner surface 110 of the main body 10.

As at least one bite groove 122 is formed in the bite 120 in this manner, the mouthpiece can be formed in a flexible structure so that the orientation and shape of the main body 10 can be flexibly adjusted according to the user's oral structure.

Additionally, it can alleviate the force applied to the user's temporomandibular joint, protecting the joint and increasing user convenience.

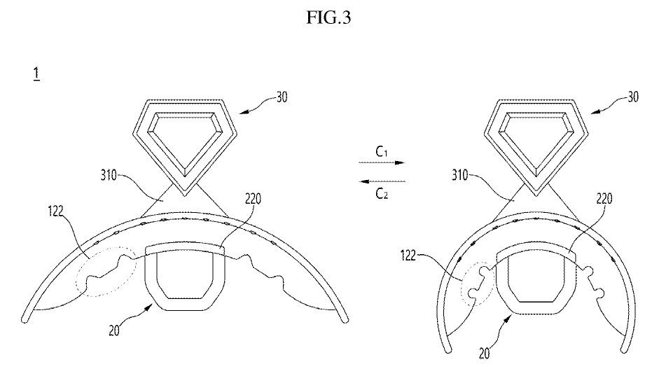

FIG. 3 is a schematic diagram illustrating the size change of the mouthpiece for whitening teeth according to a preferred embodiment.

Referring to FIG. 3, when a user with a small oral size occludes and bites the bite 120 with their teeth according to the arrow C1, the bite groove 122 folds inward according to the occlusal force of the teeth to fit the user's oral structure, thereby flexibly adjusting the size of the mouthpiece for whitening teeth 1 to be smaller.

Likewise, when a user with a large oral size occludes and bites the bite 120 with their teeth according to the arrow C2, the bite groove 122 opens outward according to the occlusal force of the teeth to fit the user's oral structure, thereby flexibly adjusting the size of the mouthpiece for whitening teeth 1 to be larger.

In this manner, the mouthpiece can increase user convenience as its size can be flexibly increased or decreased according to the user's individual oral structure and size via the bite grooves 122.

Meanwhile, referring to FIG. 2, the bite grooves 122 may be formed in an even number and arranged symmetrically left and right with respect to the tongue rest 20.

Preferably, the number of the grooves 122 may be 2 to 6, and more preferably 4 in total, with two on each side, symmetrical with respect to the tongue rest 20.

The main body 10 may further include a plurality of protrusions and a plurality of linear grooves to enhance the adhesion of the teeth whitening gel, ensuring the teeth whitening gel is uniformly applied to the tooth surface.

Referring to FIG. 1, the inner surface 110 of the main body 10 may include a plurality of point-shaped protrusions 112 protruding from it.

Furthermore, the inner surface 110 of the main body 10 may further include a plurality of linear grooves 114.

The protrusions 112 may be formed in a point shape protruding a few millimeters from the inner surface 110 of the main body 10.

In this case, the protrusions 112 may be formed as a plurality of point-shaped protrusions arranged at equal intervals.

The linear grooves 114 may be formed as linear grooves incised on the inner surface 110 of the main body 10, and preferably extend horizontally along the arc structure of the main body 10 to have a length greater than a predetermined length.

Furthermore, the plurality of linear grooves 114 may be formed at equal intervals to be parallel to each other.

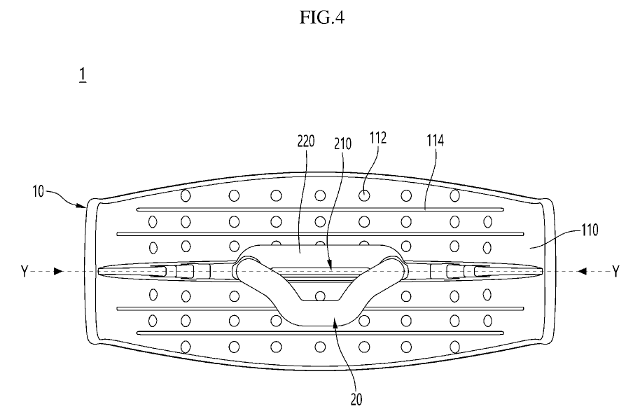

FIG. 4 is a view illustrating the inner surface 110 of the mouthpiece for whitening teeth 1 according to a preferred embodiment.

Referring to FIG. 4, the plurality of linear grooves 114 may be arranged symmetrically at the top and at the bottom with respect to the bite 120 and formed at equal intervals to be parallel to each other.

The plurality of protrusions 112 may be arranged at regular intervals in the spaces formed between the plurality of linear grooves 114.

This can improve the teeth whitening effect by enhancing the adhesion of the teeth whitening gel, ensuring the teeth whitening gel is uniformly applied to the tooth surface.

Meanwhile, the main body 10 can enhance user breathing convenience by forming an improved ventilation passage structure for smooth airflow.

Specifically, a ventilation passage is formed to penetrate the outer surface 100 and the inner surface 110 of the main body 10, and the ventilation passage is connected to the first ventilation opening 210 to allow smooth airflow.

Additionally, the ventilation assist 220 prevents the ventilation passage from shrinking even when the user occludes and bites the bite 120 with their teeth during use, thereby preventing the obstruction of airflow.

The ventilation assist 220 may have a wall structure protruding vertically from the inner surface of the bite 120.

Referring to FIG. 1, the ventilation assist 220 may be formed as a wall structure with a predetermined thickness to maintain smooth airflow in the ventilation passage.

It can prevent the ventilation passage from being pressed or shrinking, even when the user occludes and bites the bite 120 with their teeth, thereby preventing the obstruction of airflow. This allows the mouthpiece to enhance user breathing convenience by maintaining smooth airflow.

Next, the tongue rest 20 will be described more in detail.

The tongue rest 20 extends a predetermined length inward from the inner surface of the bite 120. The tongue rest 20 is connected to the ventilation assist 220 to stably hold the user's tongue and fix its position inside the oral cavity.

Referring to FIG. 2, the tongue rest 20 may be formed in a loop shape where both ends are connected to the inner surface 110 of the main body 10, so that the tongue can naturally rest on it, providing positional stability inside the oral cavity.

Referring to FIG. 4, the tongue rest 20 may have a shape where the central part of the loop structure is curved downward by a predetermined distance. This structure can minimize foreign body sensation or pain when the tongue rests on it, stably fixing the position of the tongue and preventing excessive tongue movement.

Conventional teeth whitening mouthpieces had the difficulty that the whitening gel was diluted more quickly because the tongue was not stably fixed inside the oral cavity, and tongue movement promoted saliva secretion.

To the contrary, the disclosed mouthpiece can improve the teeth whitening effect by suppressing the promotion of saliva secretion caused by tongue movement by stably fixing the tongue via the tongue rest 20, thereby preventing the whitening gel from being diluted by saliva.

Furthermore, referring to FIG. 1, the tongue rest 20 may have a structure connected to the upper part of the first ventilation opening 210. This prevents the user's tongue from covering the ventilation passage and obstructing mouth breathing, and together with the structure that blocks saliva inflow, it can provide a comfortable breathing environment for the user.

Next, the handle 30 will be described more in detail.

The handle 30 may extend a predetermined length outward from the outer surface of the main body 10. It is integrally formed with the main body 10 to assist the user in easily putting on and removing the mouthpiece. And, it can be formed in various structures to be connected to the outer surface of the main body 10, and preferably, the handle 30 may include a hole or a loop. This offers the advantage of being easy to hang or store when the mouthpiece for whitening teeth 1 is not in use.

Referring to FIG. 1, the handle 30 may further include a handle assist 310 connecting the outer surface of the main body 10 and the handle 30. The handle assist 310 may be integrally formed with the handle 30.

Referring to FIG. 1, the mouthpiece may further include a second ventilation opening 230 formed in a predetermined size on at least one surface of the handle assist 310 and connected to the ventilation passage.

Preferably, the handle assist 310 includes the second ventilation opening 230 on one surface, and may further include a third ventilation opening (240) on the adjacent other surface.

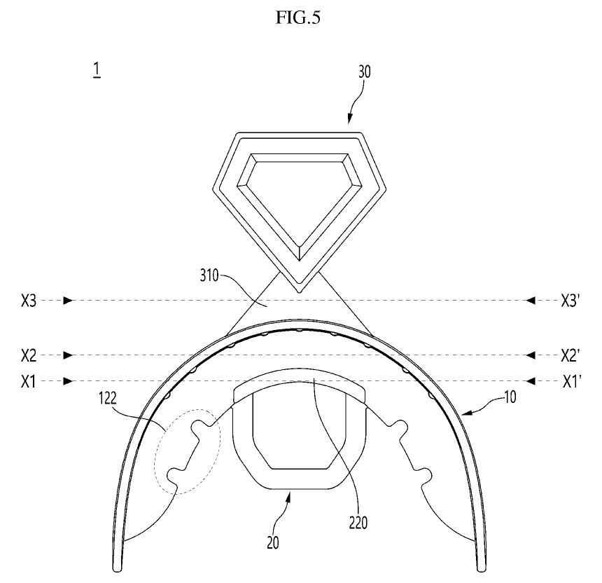

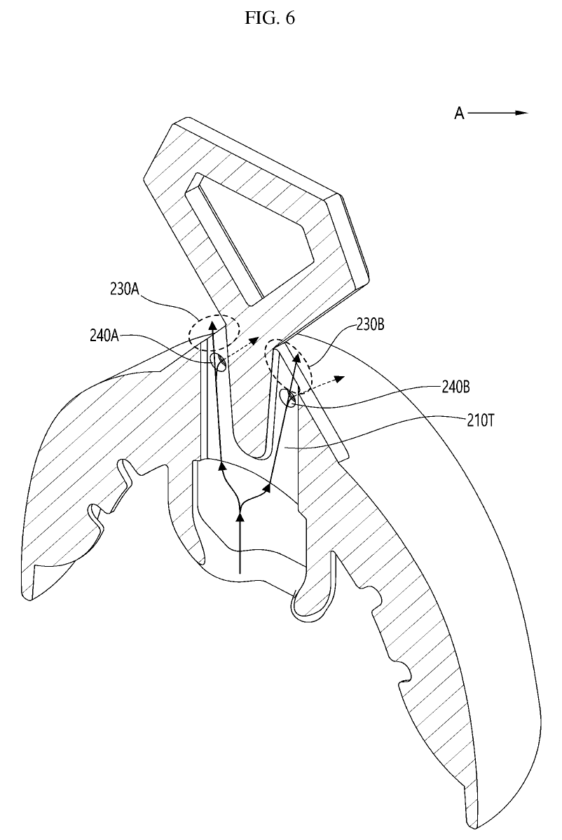

FIG. 5 is a front perspective view of the mouthpiece for whitening teeth 1 according to a preferred embodiment, and FIG. 6 is a cross-sectional view illustrating the ventilation passage and ventilation openings 210 and 230 of the mouthpiece for whitening teeth 1 according to a preferred embodiment.

Specifically, FIG. 6 is a cross-sectional view illustrating the mouthpiece for whitening teeth 1 of FIG. 2 when cut along Y-Y'.

Referring to FIG. 6, one end of the ventilation passage 210T formed to penetrate the outer surface 100 and the inner surface 110 of the main body 10 is connected to the first ventilation opening 210, and the other end of the ventilation passage may be connected to the second ventilation opening 230.

In this case, the second ventilation openings 230A and 230B may be formed in a plurality of openings on one surface of the handle assist 310, symmetrical with respect to the center point of the handle 30.

The ventilation passage 210T may be branched into multiple paths from the first ventilation opening 210 and extended to each of the plurality of second ventilation openings 230A and 230B as indicated by arrow A.

In some embodiments, the ventilation passage 210T may be extended to be branched to the third ventilation openings 240A and 240B formed on the bottom surface of the handle assist 310.

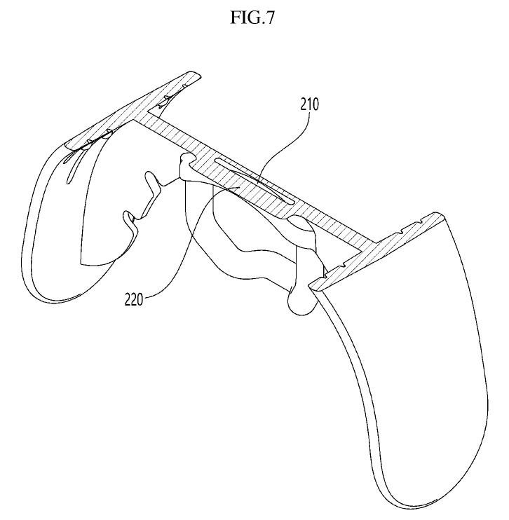

FIG. 7 is a cross-sectional view illustrating the ventilation passage 210T and ventilation openings 210 and 230 of the mouthpiece for whitening teeth 1 according to a preferred embodiment.

Specifically, FIG. 7 is a cross-sectional view illustrating the mouthpiece for whitening teeth 1 of FIG. 5 when cut along X1-X1'.

Referring to FIG. 7, the first ventilation opening 210 is formed in a predetermined size on one surface of the ventilation assist 220 and is connected to the ventilation passage 210T. The first ventilation opening 210 may be formed in various shapes with a symmetrical structure, and preferably in an oval or rectangular shape.

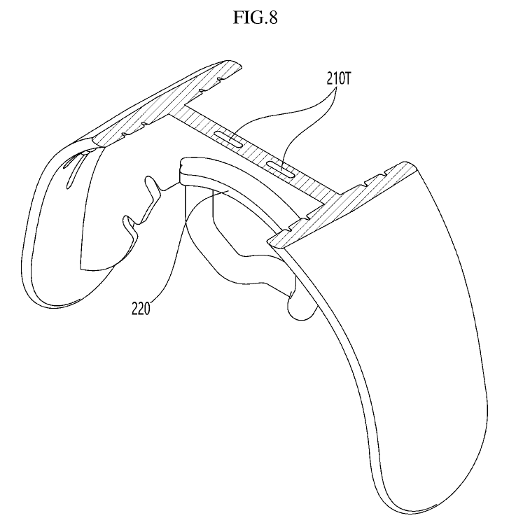

FIG. 8 is a cross-sectional view illustrating the ventilation passage 210T and ventilation openings 210 and 230 and 240 of the mouthpiece for whitening teeth 1 according to a preferred embodiment.

Specifically, FIG. 8 is a cross-sectional view illustrating the mouthpiece for whitening teeth 1 of FIG. 5 when cut along X2-X2'.

Referring to FIG. 8, the ventilation passage 210T may be branched into multiple paths from the first ventilation opening 210 and extended.

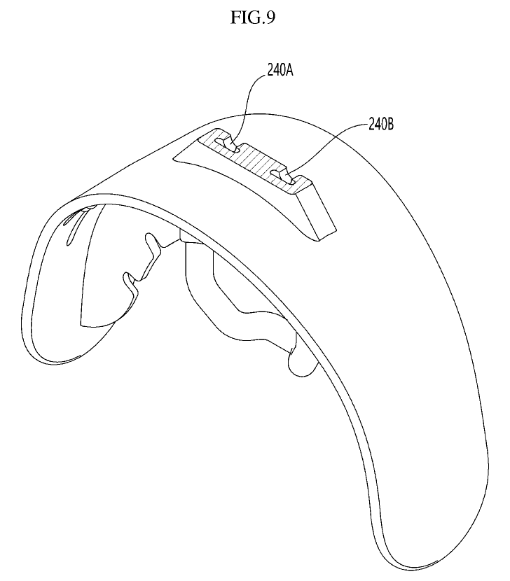

FIG. 9 is a cross-sectional view illustrating the ventilation passage 210T and ventilation openings 210 and 230 of the mouthpiece for whitening teeth 1 according to a preferred embodiment.

Specifically, FIG. 9 is a cross-sectional view illustrating the mouthpiece for whitening teeth 1 of FIG. 5 when cut along X3-X3'.

Referring to FIG. 9, the ventilation passage 210T may be branched into multiple paths from the first ventilation opening 210 and extended to each of the plurality of second ventilation openings 230A and 230B and the third ventilation openings 240A and 240B.

In this manner, the mouthpiece has a structure where the ventilation passage 210T is branched into multiple paths, which complicates the path for saliva to flow into the ventilation passage 210T, thereby preventing saliva from mixing with the teeth whitening gel, and thus improving the teeth whitening effect.

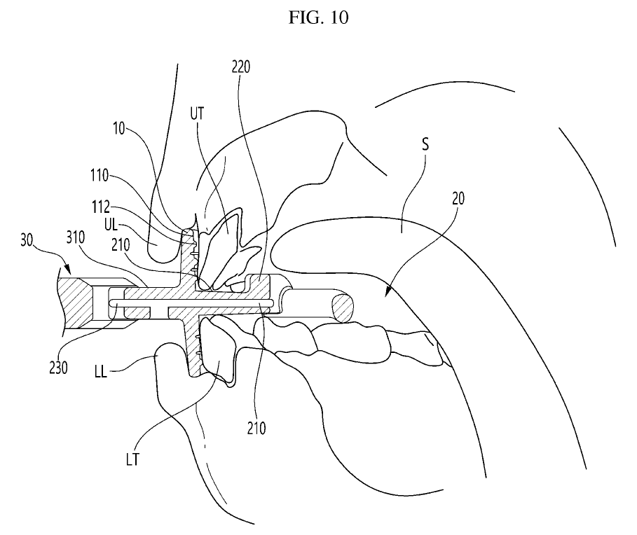

FIG. 10 is a view illustrating the state of use of the mouthpiece for whitening teeth 1 according to a preferred embodiment.

Referring to FIG. 10, the teeth whitening gel (not illustrated) is applied between the user's upper teeth UT and lower teeth LT and the inner surface 110.

The protrusions 112 and linear grooves 114 protruding from the inner surface 110 assist the teeth whitening gel in adhering to the inner surface 110, thereby improving the teeth whitening effect.

Additionally, the upper teeth UT and the lower teeth LT can occlude while being spread apart by the thickness of the bite 120. In this case, the upper lip UL and the lower lip LL can also wrap around the mouthpiece for whitening teeth 1 while spread apart.

Furthermore, the user's tongue S can be stably held by the tongue rest 20 and can rest on the upper part of the ventilation passage 210T.

In this case, the ventilation assist 220 can prevent the ventilation passage 210T from being pressed or shrinking even when the user's upper teeth UT and lower teeth LT occlude, thereby improving the user's breathing convenience.

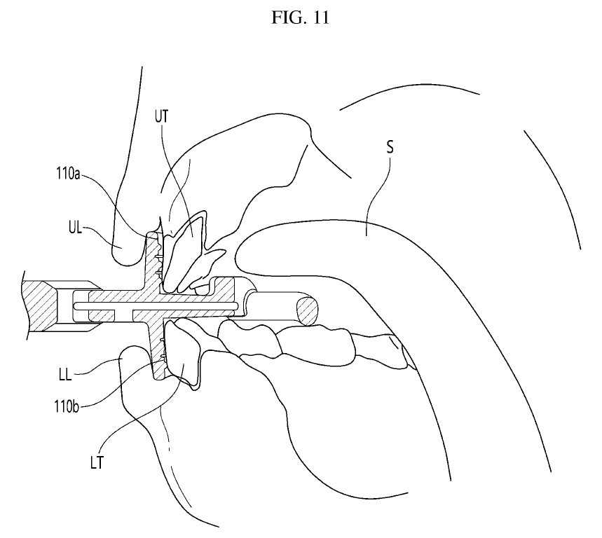

FIG. 11 is a view illustrating the state of use of the mouthpiece for whitening teeth 1 according to a preferred embodiment.

Referring to FIG. 11, the inner surface 110 of the main body 10 of the mouthpiece 1 is divided into an upper inner surface 110a and a lower inner surface 110b based on the bite 120, and may be formed in a structure where the lower inner surface 110b is more inwardly protruding than the upper inner surface 110a.

That is, the user's oral structure typically has the upper teeth UT protruding more outwardly than the lower teeth LT. The mouthpiece for whitening teeth 1 is formed so that the lower inner surface 110b protrudes more inwardly toward the oral cavity than the upper inner surface 110a to overcome the step difference between the upper teeth UT and the lower teeth LT caused by this characteristic of the human oral structure.

Accordingly, the mouthpiece can enhance wearing comfort and convenience during the occlusion of the upper teeth UT and the lower teeth LT.

In this case, it is preferable that the lower inner surface 110b of the main body 10 is formed to protrude 0.5 to 2 mm more inwardly toward the oral cavity than the upper inner surface 110a.

More preferably, the lower inner surface 110b of the main body 10 may protrude 0.7 to 1.2 mm more inwardly toward the oral cavity than the upper inner surface 110a.

This can easily overcome the occlusal step difference during the occlusion of the user's upper teeth UT and lower teeth LT, thereby enhancing wearing comfort and convenience.

Ultimately, the mouthpiece for whitening teeth 1 can include structural improvements designed to enhance user breathing convenience by forming an improved ventilation passage structure for smooth airflow, and to improve the whitening effect by blocking saliva inflow and preventing the saliva-induced dilution of the teeth whitening gel.

As described above, the mouthpiece can enhance user breathing convenience by forming an improved ventilation passage structure for smooth airflow.

Furthermore, the mouthpiece can improve the whitening effect by including structural improvements designed to block saliva inflow and enhance the adhesion of the teeth whitening gel, ensuring the teeth whitening gel is uniformly applied to the tooth surface.

Additionally, the mouthpiece is formed with a flexible structure so that its orientation and shape can be flexibly adjusted according to the user's oral structure, and the pressure generated during the occlusion of the user's upper and lower teeth is distributed, thereby alleviating the load applied to the user's temporomandibular joint and improving user convenience.

The foregoing description is merely an illustration of the technological concept of one embodiment, and various modifications and changes can be made within the scope without departing from the essential characteristics of the present embodiment for those skilled in the art to which the present embodiment belongs. Therefore, the scope of protection of the present embodiment should be interpreted according to the claims below, and all technological concepts within the scope of the claims should be included in the scope of the present embodiment.

What is claimed is:

1. A mouthpiece for whitening teeth, comprising:
a main body, which is formed in an arc shape having an outer surface and an inner surface, comprises a ventilation passage formed to penetrate the outer and inner surfaces, and is formed in a flexible structure so that its orientation and shape can be flexibly adjusted according to the user's oral structure;
a bite, which extends a predetermined length inward from the inner surface of the main body in an arc shape, providing a biting surface during use;
a tongue rest, which extends inward from the inner surface of the bite; and
a handle, which extends outward from the outer surface of the main body;
wherein the bite includes: a ventilation assist, which protrudes a predetermined length vertically from the inner surface of the bite; and a first ventilation opening, which is formed in a predetermined size on one surface of the ventilation assist and is connected to the ventilation passage.

2. The mouthpiece for whitening teeth of claim 1,
wherein the bite includes at least one bite groove formed to be concavely recessed toward the inner surface of the main body, and the orientation and shape are flexibly adjusted according to the user's oral structure by the bite groove.

3. The mouthpiece for whitening teeth of claim 2,
wherein the bite grooves are formed in an even number and arranged symmetrically at left and right side.

4. The mouthpiece for whitening teeth of claim 1,
wherein the ventilation assist has a wall structure protruding vertically from the inner surface of the bite, and
wherein the ventilation assist is formed with a predetermined thickness to maintain smooth airflow in the ventilation passage.

5. The mouthpiece for whitening teeth of claim 1, further comprising:
a handle assist connecting the outer surface of the main body and the handle; and
a second ventilation opening formed in a predetermined size on at least one surface of the handle assist and connected to the ventilation passage.

6. The mouthpiece for whitening teeth of claim 5,
wherein the second ventilation openings are formed in a plurality of openings on one surface of the handle assist, symmetrical with respect to the centerline of the handle, and
wherein the ventilation passage is branched into multiple paths from the first ventilation opening and extended to each of the plurality of second ventilation openings.

7. The mouthpiece for whitening teeth of claim 1,
wherein the inner surface of the main body further comprises a plurality of protrusions formed to protrude, enhancing the adhesion of the teeth whitening gel so that the teeth whitening gel is uniformly applied to the tooth surface.

8. The mouthpiece for whitening teeth of claim 1,
wherein the inner surface of the main body further comprises a plurality of linear grooves to enhance the adhesion of the teeth whitening gel so that the teeth whitening gel is uniformly applied to the tooth surface.

9. The mouthpiece for whitening teeth of claim 1,
wherein the average thickness of the main body is 1 to 2 mm.

10. The mouthpiece for whitening teeth of claim 1,
wherein the tongue rest is connected to the ventilation assist to stably hold the user's tongue and fix its position inside the oral cavity.

11. The mouthpiece for whitening teeth of claim 1,
wherein the handle is integrally formed with the main body to assist the user in easily putting on and removing the mouthpiece.
